(19) United States
(12) Patent Application Publication
(10) Pub. No.: US 2023/0232925 A1
(43) Pub. Date: Jul. 27, 2023

(54) BIODEGRADABLE HAIRPIN

(71) Applicant: Shih-Ling HSU, Tainan City (TW)

(72) Inventor: Shih-Ling HSU, Tainan City (TW)

(21) Appl. No.: 17/829,031

(22) Filed: May 31, 2022

(30) Foreign Application Priority Data
Jan. 26, 2022 (TW) 111201092

(51) Int. Cl. A41G 5/00; C08L 67/04; C08L 67/02

(52) U.S. Cl. CPC A41G 5/0073; C08L 67/04; C08L 67/02; C08L 2201/06

(57) ABSTRACT

A biodegradable hairpin contains: a first clip, a second clip, and a C-shaped flexible retainer. The C-shaped flexible retainer includes a first leg, a second leg, an opening, a peak portion, a first shoulder, and a second shoulder. An inner wall of the C-shaped flexible retainer extends to the first leg and the second leg from the peak portion along a parabolic track, such that a thickness of a cross section of the peak portion is 1.666 times more than a thickness of a cross section of the first leg and a thickness of a cross section of the second leg. The biodegradable hairpin is made of any one or a combination of at least two of Bio-Polybutylene Succinate (PBS), Polylactic acid (PLA), D-polylactide (PDLA), toughener, and nucleating agent, such that the biodegradable hairpin has ductility, malleability, and toughness.

### FIELD OF THE INVENTION

The present invention relates to a biodegradable hairpin.

### BACKGROUND OF THE INVENTION

A conventional hairpin contains: two clips, a spring, and a coupling shaft configured to connect the two clips and the spring, such that the hairpin is applied to fix user's hairs by ways of the two clips. However, the spring of the hairpin exposes outside to cause a poor appearance and rustiness and to injure user's finger(s). On the other hand, the conventional hairpin is applied to have hair styling and decorate on the user's hairs, wherein the conventional hairpin is made of plastic material to obtain lightweight, and the conventional hairpin is made of Polycarbonate (PC), Polypropylene (PP), or ABS resin (acrylonitrile, butadiene, styrene copolymer). However, such plastic material is indecomposable, thus having environmental pollution.

To solve above-mentioned problem, an improved hairpin has been developed and is made of Polylactic acid (PLA), but it has poor strength, toughness, flexibility and high-temperature resistance. When connecting the two clips rotatably, a rotatable connection portion of the two clips is provided with a flexible element, yet the rotatable connection portion is broken easily since it is made of Polylactic acid.

The present invention has arisen to mitigate and/or obviate the afore-described disadvantages.

### SUMMARY OF THE INVENTION

The primary aspect of the present invention is to provide a biodegradable hairpin which has ductility, malleability, and toughness.

To obtain above-mentioned aspect, a biodegradable hairpin provided by the present invention contains: a first clip, a second clip, and a C-shaped flexible retainer.

The C-shaped flexible retainer includes a first leg, a second leg, an opening defined between the first leg and the second leg, a peak portion formed opposite to the opening, a first shoulder extending from the peak portion to the first leg, and a second shoulder extending from the peak portion to the second leg.

A profile of an outer wall of the C-shaped flexible retainer is circular, and an inner wall of the C-shaped flexible retainer extends to the first leg and the second leg from the peak portion along a parabolic track, such that a thickness between the inner wall and the outer wall of the C-shaped flexible retainer reduces gradually from the peak portion to the first leg and the second leg, and a thickness of a cross section of the peak portion is 1.666 times more than a thickness of a cross section of the first leg and a thickness of a cross section of the second leg;

The biodegradable hairpin is made of any one or a combination of at least two of Bio-Polybutylene Succinate (PBS), Polylactic acid (PLA), D-polylactide (PDLA), toughener, and nucleating agent, such that the biodegradable hairpin has ductility, malleability, and toughness.

The toughener is any one or a combination of at least two of Polyethylene terephthalate, Theromplastic elastomer ester resin, Polyester polyol resin, and Vinyl ester resin.

The nucleating agent is any one or a combination of at least two of calcium carbonate, talc, silicon dioxide, and mica.

### BRIEF DESCRIPTION OF THE DRAWINGS

FIG. 1 is a perspective view showing the assembly of a biodegradable hairpin according to a preferred embodiment of the present invention.

FIG. 2 is a perspective view showing the exploded components of the biodegradable hairpin according to the preferred embodiment of the present invention.

FIG. 3 is a side plan view showing the assembly of a C-shaped flexible retainer of the biodegradable hairpin according to the preferred embodiment of the present invention.

FIG. 4 is a side plan view showing the assembly of a C-shaped flexible retainer of the biodegradable hairpin according to another preferred embodiment of the present invention.

FIG. 5 is a cross sectional view showing the assembly of the C-shaped flexible retainer of the biodegradable hairpin according to another preferred embodiment of the present invention.

FIG. 6 is a perspective view showing the assembly of a C-shaped flexible retainer of a biodegradable hairpin according to another preferred embodiment of the present invention.

FIG. 7 is a perspective view showing the assembly of a C-shaped flexible retainer of a biodegradable hairpin according to another preferred embodiment of the present invention.

### DETAILED DESCRIPTION OF THE PREFERRED EMBODIMENTS

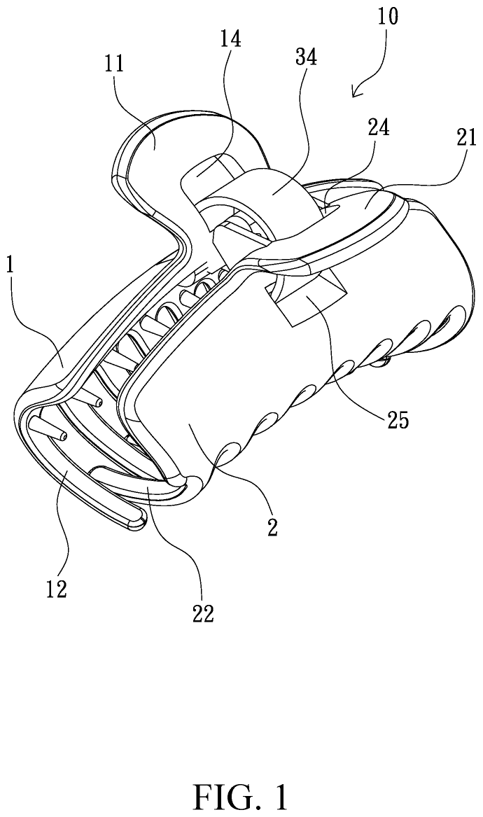

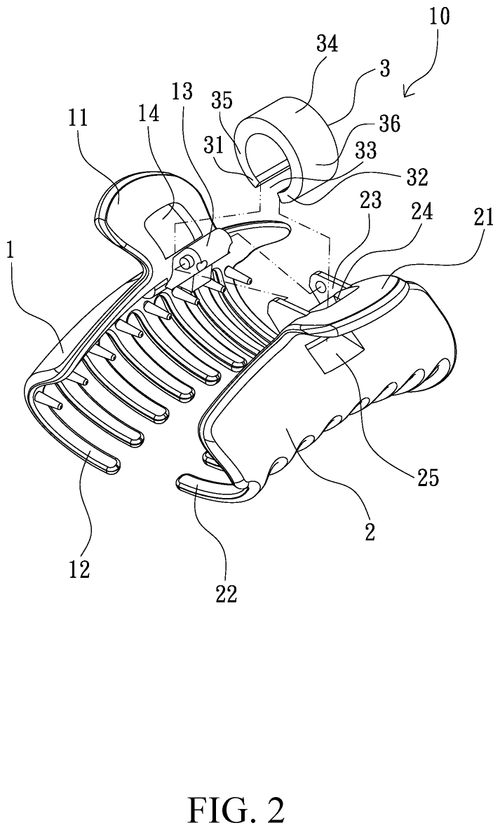

With reference to FIGS. 1 and 2, a biodegradable hairpin 10 according to a preferred embodiment of the present invention comprises: a first clip 1, a second clip 2, and a C-shaped flexible retainer 3 connected with the first clip 1 and the second clip 2, wherein the C-shaped flexible retainer includes a first leg 31, a second leg 32, an opening 33 defined between the first leg 31 and the second leg 32, a peak portion 34 formed opposite to the opening 33, a first shoulder 35 extending from the peak portion 34 to the first leg 31, and a second shoulder 36 extending from the peak portion 34 to the second leg 32. A profile of an outer wall of the C-shaped flexible retainer 3 is circular, and an inner wall of the C-shaped flexible retainer 3 extends to the first leg 31 and the second leg 32 from the peak portion 34 along a parabolic track, such that a thickness between the inner wall and the outer wall of the C-shaped flexible retainer 3 reduces gradually from the peak portion 34 to the first leg 31 and the second leg 32, and a thickness of a cross section of the peak portion 34 is 1.666 times more than a thickness of a cross section of the first leg 31 and a thickness of a cross section of the second leg 32, wherein a calculation error range is plus or minus 1.11 times.

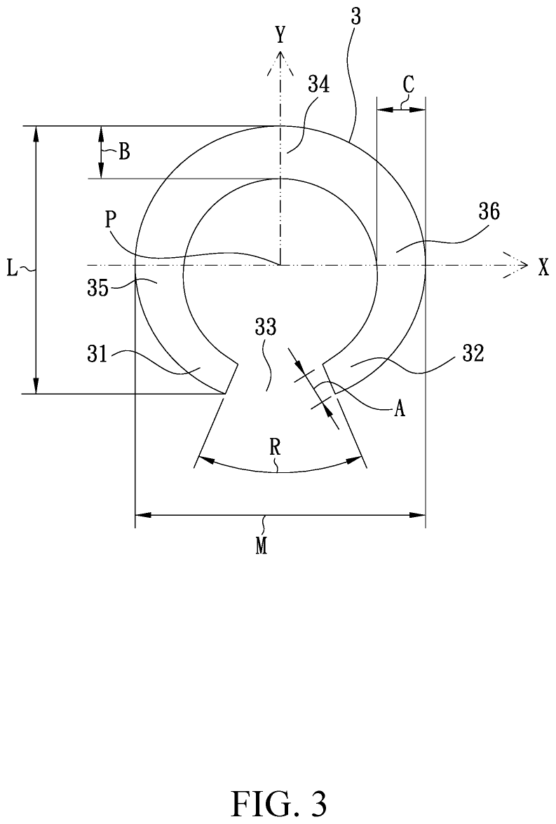

As shown in FIG. 3, a center of an outer circumference of the C-shaped flexible retainer 3 is P, the thickness of the cross section of the first leg 31 and the thickness of the cross section of the second leg 32 are A, and a thickness of a cross section of the peak portion 34 is B, wherein the thickness B is 1.666 times more than the thickness A, i.e. thickness B=1.66 A, a thickness of a cross section of the first shoulder 35 and a thickness of a cross section of the second shoulder 36 are C, wherein the thickness C is 1.52 times more than the thickness A, i.e. the thickness C=1.52 A, a longitudinal distance between the peak portion 34 and the first leg 31 and a longitudinal distance between the peak portion 34 and the second leg 32 are L, wherein the longitudinal distance L is 8.8 times more than the thickness A, i.e. the longitudinal distance L=8.8 A, and a horizontal distance between the first shoulder 35 and the second shoulder 36 is M, wherein the horizontal distance M is 9.19 times more than the thickness A, i.e. the horizontal distance M=9.19 A. An angle of the opening 33 between the first leg 31 and the second leg 32 is R, and the angle R is also defined among the first leg 31, the second leg 32, and the center P, wherein the angle R is within 30 degrees to 50 degrees.

For example, the center of the outer circumference of the C-shaped flexible retainer 3 is P, the thickness of the cross section of the first leg 31 and the thickness of the cross section of the second leg 32 are A, wherein the thickness A is 2.1 mm, and the thickness of the cross section of the peak portion 34 is a B, wherein the thickness B is 1.666 times more than the thickness A, i.e. the thickness B=1.666×2.1 mm=3.5 mm, and the thickness of the cross section of the first shoulder 35 and the thickness of the cross section of the second shoulder 36 are C, wherein the thickness C is 1.52 times more than the thickness A, i.e. the thickness C=1.52×2.1 mm=3.2 mm. The longitudinal distance between the peak portion 34 and the first leg 31 and the longitudinal distance between the peak portion 34 and the second leg 32 are L, wherein the longitudinal distance L is 8.8 times more than the thickness A, i.e. the longitudinal distance L=8.8×2.1 mm=18.5 mm. The horizontal distance between the first shoulder 35 and the second shoulder 36 is M, wherein the horizontal distance M is 9.19 times more than the thickness A, i.e. the distance M=9.19×2.1 mm=19.3 mm. The angle R of the opening 33 between the first leg 31 and the second leg 32 of the C-shaped flexible retainer is 46 degrees.

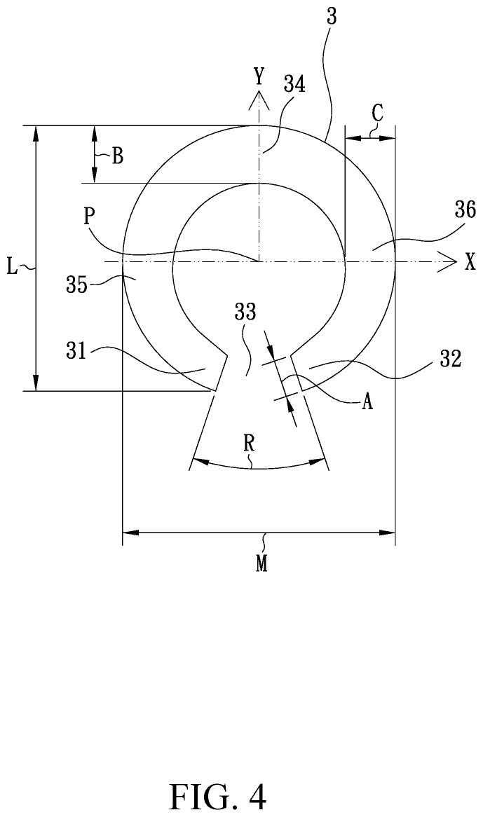

Referring to FIG. 4, the center of the outer circumference of the C-shaped flexible retainer 3 is P, the longitudinal distance between the peak portion 34 and the first leg 31 and the longitudinal distance between the peak portion 34 and the second leg 32 are L, wherein the longitudinal distance L is 7.86 times more than the thickness A, i.e. the longitudinal distance L=7.86 A. The horizontal distance between the first shoulder 35 and the second shoulder 36 is M, wherein the horizontal distance M is equal to the longitudinal distance L. In another embodiment, the center of the outer circumference of the C-shaped flexible retainer 3 is P, the thickness of the cross section of the first leg 31 and the thickness of the cross section of the second leg 32 are A, and the thickness A is 1.8 mm. The longitudinal distance between the peak portion 34 and the first leg 31 and the longitudinal distance between the peak portion 34 and the second leg 32 are L, wherein the longitudinal distance L is 7.87 times more than the thickness A, i.e. the longitudinal distance L=7.87×1.8 mm=14.16 mm. The horizontal distance between the first shoulder 35 and the second shoulder 36 is M, wherein the horizontal distance M is equal to the longitudinal distance L, i.e. the horizontal distance M and the longitudinal distance L are 14.16 mm. The thickness of the cross section of the peak portion 34 is B, wherein the thickness B is 1.666 times more than the thickness A, i.e. the thickness B=1.66×1.8 mm=2.99 mm. The thickness of the cross section of the first shoulder 35 and the thickness of the cross section of the second shoulder 36 are C, wherein the thickness C is 1.52 times more than the thickness A, i.e. the thickness C=1.52×1.8 mm=2.7 mm. An angle of the opening 33 between the first leg 31 and the second leg 32 is R, and the angle R is also defined among the first leg 31, the second leg 32, and the center P, wherein the angle R is 37 degrees.

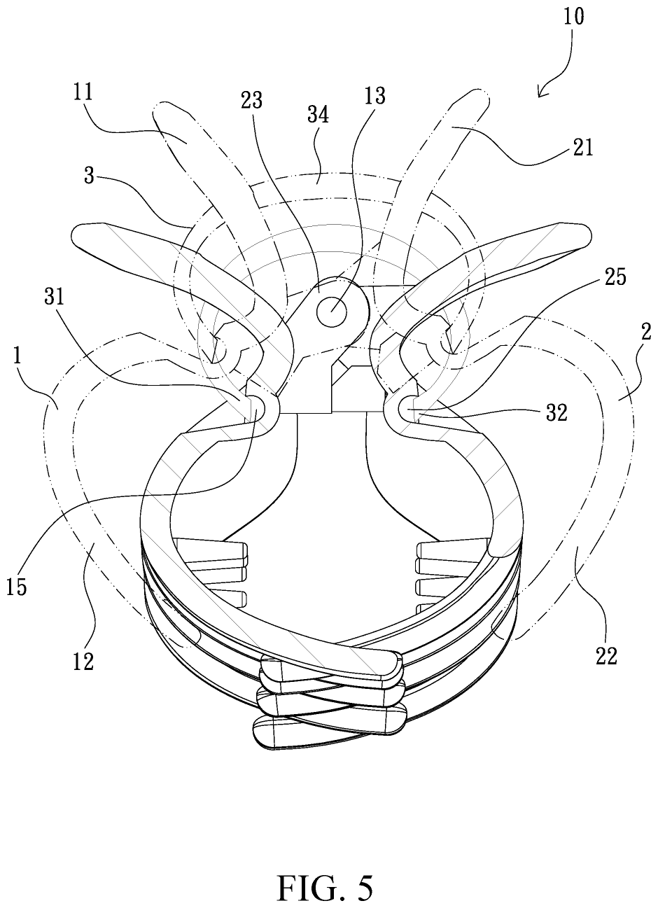

With reference to FIGS. 2 and 5, the first clip 1 further includes a first press portion 11, a first clamp portion 12 extending downward from the first press portion 11, a first rotatable connection portion 13 formed on an inner wall of the first clip 1, a first through orifice 14 defined on the first press portion 11, and a first trench 15 formed on an outer wall of the first clip 1 adjacent to the first press portion 11. The second clip 2 includes a second press portion 21, a second clamp portion 22 extending downward from the second press portion 21, a second rotatable connection portion 23 formed on an inner wall of the second clip 2 and rotatably connected with the first rotatable connection portion 13, a second through orifice 24 defined on the second press portion 21, and a second trench 25 formed on an outer wall of the second clip 2 proximate to the second press portion 21.

The biodegradable hairpin 10 is made of any one or a combination of at least two of Bio-Polybutylene Succinate (PBS), Polylactic acid (PLA), D-polylactide (PDLA), toughener, and nucleating agent, wherein the toughener is any one or a combination of at least two of Polyethylene terephthalate, Theromplastic elastomer ester resin, Polyester polyol resin, and Vinyl ester resin, wherein the nucleating agent is any one or a combination of at least two of calcium carbonate, talc, silicon dioxide, and mica.

When connecting the biodegradable hairpin 10, the first clip 1 is rotatably connected with the second clip 2 by using the first rotatable connection portion 13 and the second rotatable connection portion 23, the first leg 31 is inserted through of the first through orifice 14 of the first press portion 11 of the first clip 1 to engage with or abut against the first trench 15 of the first clip 1. Thereafter, the second leg 32 is inserted through of the second through orifice 24 of the second press portion 21 of the second clip 2 to engage with or abut against the second trench 25 of the second clip 2, thus producing a flexible clamping force of the biodegradable hairpin 10 after connecting the biodegradable hairpin 10.

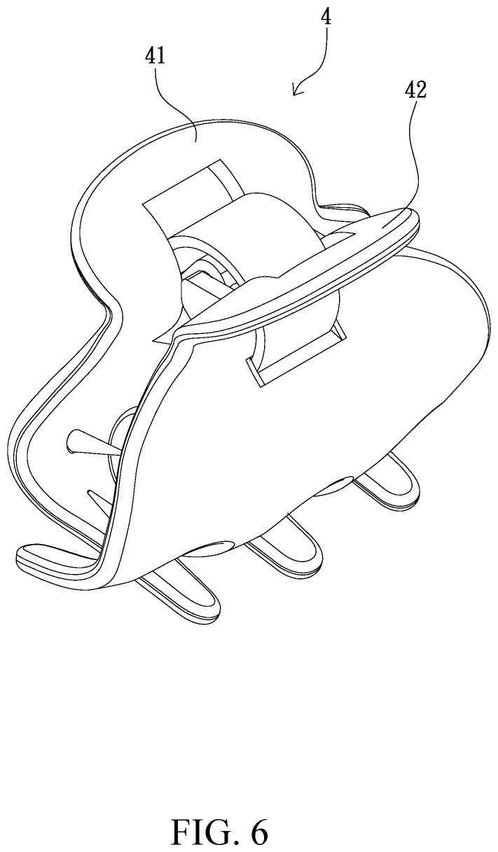

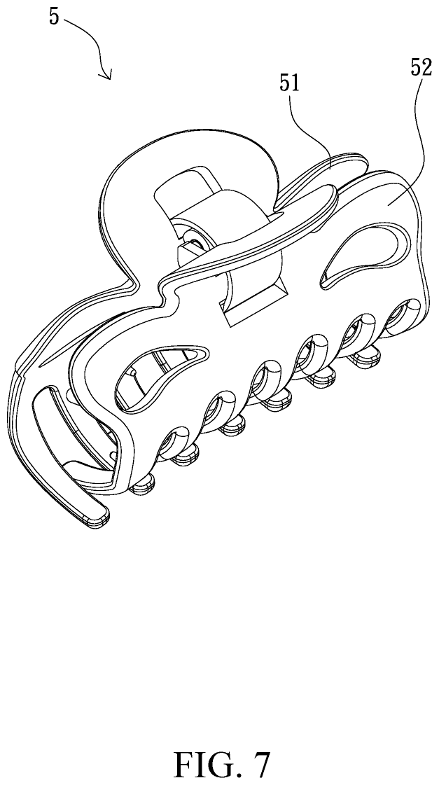

As shown in FIG. 6 and FIG. 7, profiles of first clips 41, 51 and second clips 42, 52 of the biodegradable hairpins 4, 5 are different from the profile of the biodegradable hairpin 10 of the first embodiment, wherein the profiles of the first clips 41, 51 and the second clips 42, 52 of the biodegradable hairpins 4, 5 are formed based on using requirements.

Thereby, the C-shaped flexible retainer 3 has ductility, malleability, and toughness. Preferably, the biodegradable hairpin 10 is biodegradable to be environmental friendly.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A biodegradable hairpin comprising:
a first clip, a second clip, and a C-shaped flexible retainer connected with the first clip and the second clip, wherein the C-shaped flexible retainer includes a first leg, a second leg, an opening defined between the first leg and the second leg, a peak portion formed opposite to the opening, a first shoulder extending from the peak portion to the first leg, and a second shoulder extending from the peak portion to the second leg;
wherein a profile of an outer wall of the C-shaped flexible retainer is circular, and an inner wall of the C-shaped flexible retainer extends to the first leg and the second leg from the peak portion along a parabolic track, such that a thickness between the inner wall and the outer wall of the C-shaped flexible retainer reduces gradually from the peak portion to the first leg and the second leg, and a thickness of a cross section of the peak portion is 1.666 times more than a thickness of a cross section of the first leg and a thickness of a cross section of the second leg;
wherein the biodegradable hairpin is made of any one or a combination of at least two of Bio-Polybutylene Succinate (PBS), Polylactic acid (PLA), D-polylactide (PDLA), toughener, and nucleating agent, such that the biodegradable hairpin has ductility, malleability, and toughness.

2. The biodegradable hairpin as claimed in claim 1, wherein a center of an outer circumference of the C-shaped flexible retainer is P, the thickness of the cross section of the first leg and the thickness of the cross section of the second leg are A, and a thickness of a cross section of the peak portion is B, wherein the thickness B is 1.666 times more than the thickness A, a calculation error range is plus or minus 1.11 times, wherein a thickness of a cross section of the first shoulder and a thickness of a cross section of the second shoulder are C, wherein the thickness C is 1.52 times more than the thickness A, and the calculation error range is plus or minus 1.11 times.

3. The biodegradable hairpin as claimed in claim 2, wherein a longitudinal distance between the peak portion and the first leg and a longitudinal distance between the peak portion and the second leg are L, the longitudinal distance L is 8.8 times more than the thickness, and a horizontal distance between the first shoulder and the second shoulder is M, wherein the horizontal distance M is 9.19 times more than the thickness A.

4. The biodegradable hairpin as claimed in claim 2, wherein the center of the outer circumference of the C-shaped flexible retainer is P, the longitudinal distance between the peak portion and the first leg and the longitudinal distance between the peak portion and the second leg are L, wherein the longitudinal distance L is 7.86 times more than the thickness A, and the horizontal distance between the first shoulder and the second shoulder is M, wherein the horizontal distance M is equal to the longitudinal distance L.

5. The biodegradable hairpin as claimed in claim 2, wherein an angle of the opening between the first leg and the second leg is R, and the angle R is also defined among the first leg, the second leg, and the center P, wherein the angle R is within 30 degrees to 50 degrees.

6. The biodegradable hairpin as claimed in claim 1, wherein the first clip further includes a first press portion, a first clamp portion extending downward from the first press portion, a first rotatable connection portion formed on an inner wall of the first clip, a first through orifice defined on the first press portion, and a first trench formed on an outer wall of the first clip adjacent to the first press portion; the second clip includes a second press portion, a second clamp portion extending downward from the second press portion, a second rotatable connection portion formed on an inner wall of the second clip and rotatably connected with the first rotatable connection portion, a second through orifice defined on the second press portion, and a second trench formed on an outer wall of the second clip proximate to the second press portion.

7. The biodegradable hairpin as claimed in claim 1, wherein the toughener is any one or a combination of at least two of Polyethylene terephthalate, Theromplastic elastomer ester resin, Polyester polyol resin, and Vinyl ester resin.

8. The biodegradable hairpin as claimed in claim 7, wherein the nucleating agent is any one or a combination of at least two of calcium carbonate, talc, silicon dioxide, and mica.
